(19) United States
(12) Patent Application Publication
(10) Pub. No.: US 2003/0158771 A1
(43) Pub. Date: Aug. 21, 2003

(54) Retention modeling methodology for airlines

(75) Inventors: Xi Shen, Moranville, NJ (US); Dawn Burnett, Scotch Plains, NJ (US); Nagar Vishwanath, Basking Ridge, NJ (US); Yung-Seop Lee, Seoul (KR)

Correspondence Address: James M. Stover, NCR Corporation, WHQ-4West, 1700 South Patterson Blvd., Dayton, OH, 45479-0001, US

(73) Assignee: NCR Corporation

(21) Appl. No.: 10/046,226

(22) Filed: Jan. 16, 2002

(51) Int. Cl. G06F 17/60

(52) U.S. Cl. 705/10

(57) ABSTRACT

A method of building a customer retention model for commercial passenger airlines industry is described. The major contributions of this invention are: By carefully and thoroughly investigating the background and the current deregulated, competitive environment of the airline industry, a competitive market approach of defining retention for this industry is proposed in detail. A new Customer Value Metric Model (CVMM) is proposed and described. A variety of calculating methods is presented. These methods will provide airline industry more accurate and balanced measures of their high valued customers. Data elements and data sources, both internal and external, are discussed and identified. These data elements are also ranked by their potential use to the retention model. A detailed, step-by-step data analysis and model building process is described, which serves as a guideline to any analysts, project managers or other personnel who may be involved in such an engagement.

### FIELD OF THE INVENTION

The present invention relates generally to retention modeling methodologies, and more particularly, to a retention modeling methodology for airlines.

### BACKGROUND ART

The airline industry is one of the leading industries in today's world. By one estimate, the U.S. airline's annual revenue in 1997 was $88 billion, of which, 90%, or $79.5 billion was from passenger fares. In the U.S. domestic air travel accounts for 78% of total air traffic, while international travel accounts for 22%. For all the air traffic in the U.S., 40% of enplanements are for business travel and 60% are for vacation or personal travel.

Since the late 1970's, along with the deregulation of the U.S. commercial airline industry, the competition in the airline industry has intensified. With the increase in competition has come an increased emphasis on retention of valued customers. Across most industries the basic assumption of customer relationship management is that the cost of customer acquisition is much greater than the cost of customer retention, (i.e., it costs less to retain existing customers then to gain new customers. Thus it is very important to airlines to retain valued customers).

A solution using internal and external data and professional services to identify those customers “at risk” of changing their air travel carriers could greatly reduce the time and cost to retain high-valued customers. Consequently, by implementation of such a solution, including improved service process and successful marketing campaigns, a company could achieve the goal of retaining its high-valued customers.

In order to understand the retention question in the Airline Industry, it is important to understand the airline industry and its business process. The section that follows describes briefly the fundamentals of the airline industry, the airline industry of the U.S. in particular. Then the next section is a description of the business process.

Fundamentals of the Passenger Airline Industry

The Effect of Deregulation in the U.S. and Stagflation in the Early 1980's

The current passenger airline industry is the result of the evolution of the industry from the U.S. airline deregulation. The airline deregulation is officially marked by the U.S. Congress enacting the Airline Deregulation Act (ADA) in October 1978. The years immediately following the passage of ADA constituted a period of high inflation accompanied by significant economic slowdown (thus the term Stagflation in economic literature), caused mainly by an unprecedented increase in oil prices (so called oil shock). Jet fuel prices skyrocketed to all time highs during the period from 1979 to 1982 causing the airlines' operating costs to increase more than 50 percent. The rapid increase in the price of oil not only pushed up costs of the airline industry, but also dragged down the U.S. economy into a recession in 1980.

Since air travel is very sensitive to cost, and to the economic environment in general, the combination of higher air fares and recession led to a substantial decline in traffic volume and profit for airlines. This unfavorable economic environment plus the uncertainty of the marketplace brought about by deregulation forced the airline industry into tremendous hardship. Most airlines were ill-prepared for the deregulated competitive marketplace. Many airlines went bankrupt. Some major airlines have been out of business ever since; some others recovered from this situation by either becoming low cost carriers or re-inventing themselves with new ownership and management.

Today, there are basically no economic regulations imposed on the U.S. airline industry. Without price ceilings, the airlines determine the fare and the discount based on their operational costs and marketing concerns. Without route regulation the airlines now have more freedom to design their own route network. The removal of market entry barriers allows new carriers to enter, and local carriers to expand into interstate, long haul services.

The competition following deregulation has changed the landscape of the entire airline industry. Some well known, trunk carriers ceased operations, while some lesser known local or intrastate carriers became major players in the interstate marketplace. The barrier which regulation established between local, intrastate carriers and long-haul, interstate carriers has disappeared, an in this new environment, the airlines have developed a hub-and-spoke routing network.

Development and Effects of Hub-and-Spoke Routing Network

The flight services offered by airlines basically are short haul and long haul. For the U.S. airline industry, short haul means less than one hour jet flight, (i.e., mostly) intrastate or local, and long haul means long distance flight, (i.e., mostly) interstate.

There are roughly 50,000 city-pairs between which passengers travel within the United States. Each pair is customarily called a “market” in airline industry. However, the nature of economies of scale in aircraft determines that only about 2,000 of these markets have nonstop service. In most markets, passengers have to make an intermediate stop and change planes en route to their ultimate destinations. Such routing is most common for passengers traveling to and from small or midsize cities where there is not sufficient traffic volume to justify nonstop service. The benefits of air travel are speed and convenience. Any problems causing delay or long waiting times will not be tolerable. Passengers prefer to use a single airline for their trips, thus reducing difficulties and potential risks.

For airlines, larger aircraft generally have lower average operating costs per seat mile. However, for short hauls of up to 1,000 miles, twin-engine aircraft do not have a much higher average operating cost per available seat-mile compared to larger aircraft. Smaller aircraft require fewer pilots and service crews and offer higher fuel efficiency. The development of the hub-and-spoke route network helped the local carriers (for example, USAir) expand into the longer haul markets. Some of the trunk carriers (such as Delta and United) also quickly adapted their route network design and developed hub-and-spoke operations at major airports throughout the United States. Now, shorter haul routes operated by twin-engine smaller aircraft serve as “feeders” to the airline's major hubs. At each hub, the airline operates hundreds of flights everyday, with densely scheduled arrival and departing flights (called bank). This provides ample possibilities of connections. Today, most major United States airlines operate hub-and-spoke networks.

As a consequence of the hub-and-spoke routing network, a high proportion of a carrier's flights originate or terminate at an airport where it operates a hub. The airlines provide much less nonstop services to city-pairs. This network gives airlines benefits of economies of scale and allows them higher operational efficiency. One of the main measurements of an airline's operational efficiency is the load factor, which shows the percentage of seats that are filled. A thin market usually has a low load factor. With the operation of hub-and-spoke networks, airlines are able to substantially increase their load factors for the flights departing from or arriving at the hubs.

Most major cities have at least one carrier operating a hub at their airport. Some larger cities usually have more than one carrier operating hubs at their airports. One major consideration when airlines choose their hub location is the potential local traffic volume. That is, the number of travelers available in the surrounding metropolitan area. The hub-and-spoke network allows residents at these major cities to travel to most destinations with direct flights. On the other hand, travelers to or from small or midsize cities generally have flights to hubs where they can receive convenient connecting services to their ultimate destinations. The hub-and-spoke networks provide passengers the benefits of convenience, easy connection, low layover time, and direct transport of baggage, all at a reasonable price. These help make air travel more convenient and popular.

Pricing Polices of the U.S. Carriers

Though pricing policies differ among the airlines, the basic principles are the same. Fares in a thin market are generally higher than in a dense market, and the fares in the short-haul markets tend to be comparatively higher. Though competition in the marketplace drives the pricing structure, the economic reason for pricing disparity is the value of time. Air travel saves time and passengers will choose air travel when the value of the time saved by air travel is higher than the extra expense occurred. The time sensitivity of passengers is critical in determining the load factor and pricing.

Another factor that explains the airline's pricing policy is the economy of scale. The major assets of the airline are the airplanes. However, the seats on the airplane are “perishable” assets in the sense that when the airplane takes off, the unfilled seats are useless to the airline. On the other hand, the cost of serving one additional passenger on a flight is substantially low. Therefore, airlines have a strong incentive to increase the number of passengers on their flights. One way to achieve this goal is to reduce the prices; thus discount fares are important to drive the load factor. But offering across the board discount fares will lead to a reduction in revenue and airlines realize that it is important for them to target only a subset of passengers for discount. The following are common practices in the airline industry:

Restrictions associated with the discount fare—These restrictions include advance-purchase, minimum stay, non-refundable, etc. In addition, some discount fares have designated fly date. This policy will distinguish the business travelers from the leisure travelers because the business travelers usually cannot meet these restrictions.

Capacity-Control—Airlines control the number of seats available for discount fares on each flight. This policy helps airlines reduce the probability that a passenger who is willing to pay the full coach fare will not be able to get a seat on the preferred flight.

Segmented Days—The airlines segment a day's time into several time bands. The availability of seats for discounted fares is different for different time bands. For example, at peak times such as late afternoon and evening, there are fewer seats for discount fares than in non-peak time bands.

The result of the above practices is that passengers in the same flight may actually pay totally different fares even for the same service-class. However the passengers who pay higher fares are more time sensitive and prefer the flexibility to fly the flights that they select. These differences can be used to classify customers in the analytical modeling process.

International Aspects of Airline Industry

The international market is the fastest growing market for major airlines. For the major U.S. carriers, international travel accounts for 27% of total traffic and 22% of revenue. Traffic between the U.S., Europe and Latin America is growing at an estimated 10% per year. For the first four months of 1999, the growth rate was 7.6%. In Asia-Pacific, even though the economic conditions are not favorable, air travel volume is still growing, and for the first quarter of 1999, the traffic growth rate for Asian-Pacific airlines was 3.9%.

International aspects of airline industry are somewhat different from the U.S. By international, we mean the airlines of non-U.S. countries (foreign airlines) and the airlines that operate in the international market. The following are major characteristics of international airlines:

Unlike the U.S. airlines, most foreign airlines are still regulated or controlled by their respective governments.

Though most foreign airlines operate from a few major hubs in their countries, they do not operate over a vast hub-and-spoke network such as in the U.S.

Airlines' international operations are dictated by bilateral agreements. These agreements determine the city (hub) and country, and schedule.

International airlines tend to be long haul service providers and operate over a city-pair route, not with a bank of flights.

International airlines' pricing is regulated by an international organizational body of airlines, though the role of this cartel is diminishing.

These characteristics of international airlines provide advantage to retention modeling, since the customers who fly over international routes are easier to identify. The airlines operating in any particular international market are few; therefore the customers have less choice and benchmarking and marketing is easier.

A Business Process Model for Air Travel

Airlines operate flights on a predetermined schedule. The origin and destinations (O&D), the departure and arrival times, intermediate stopping points, and equipment used are all prescribed. It is very rare that a passenger carrier will fly outside their schedule. That means that air travel service is not offered “on demand.”

In general, customers select airlines based on the following considerations:

Their travel needs and how flexible their travel might be;

The availability of the flights on the specific time and route;

The pricing (fares willing to pay);

The convenience (such as departing time, change of flights en route, the duration of the flight, arrival time, the distance of the airport from their residence, etc.);

Quality of service or customer satisfaction (from their past experience with the carrier);

The benefits of the frequent flier programs if they have enrolled in any;

The competitors' offerings.

When the customer's preferred price range, timing, and O&D matches with the available flight offered by the airline, the customer can make a reservation (booking) and then purchase a ticket. The booking process can be conducted through travel agencies, or by calling directly to the airlines or via the internet. Despite the increasing usage of the internet, travel agencies are still the number one source for air travel reservation. Most business travels are booked through travel agencies and many corporations retain their own travel agencies to handle their employees' business travel needs. Through booking, the customers, with the help of travel agencies, will find a matching flight offered by an airline to their destination, on their preferred traveling time, at their accepted prices. In a competitive market, the customers usually have several choices.

The passengers can cancel their reservations before the travel happens. However, certain penalties will accrue with the cancellation, based on the type of ticket they booked. The airlines offer different levels of service: coach (economy), business, and first class. All these services generate revenue to the airlines. Of course, the higher the class of the service, the more revenue the airline earns.

Most major airlines offer frequent flier programs to their customers. When a customer is enrolled in a frequent flier program, each time the customer flies, the mileage for the length of the flight will be entered into the airline's computer system. As the customer's accumulated total mileage reaches a pre-determined level, he/she will earn the right for a bonus flight to their selected destinations or a free upgrade. From the airline's point of view, this kind of air travel is called “reward” flight. The mileage earned in reward flight will be recorded as “bonus mileage”, but the flight generates no revenue to the airline. Airlines impose restriction on when and how a frequent flyer can redeem mileage and obtain benefits.

Defining Retention

Two Types of Attrition

Retention means keeping or retaining, existing customers. The retention models described below assume that the airlines want to retain high-valued customers. The determination of which customers are high valued is discussed infra.

The need for retention activities by the airline comes from the fact that in a competitive market customers have the ability to choose their suppliers. The opposite of retention is attrition, which one author defines as follows:

“As applied to customers, it is that state in which a customer, for personal reasons, begins to question continued patronage of a supplier.”

This section first defines two types of attrition:

contractual attrition, in which a customer, who has a contract with a supplier, cancels the contract and transfers his business to another supplier; and

situational attrition, where there is no contract for services but the customer switches suppliers because the situation makes the new supplier seem more desirable.

When considering the definition of attrition for the airline industry, it must be understood that there are fundamental differences between the passenger airline industry and other industries, such as the telecommunication industry. One major characteristic for telephone services is that customers usually have an existing service contract with the carrier. This contract stipulates that the customer subscribes to the telephone services provided by the telecommunication service carrier. Through this subscription, the customer actually purchases an option to make and receive calls. This option provides customer access (not usage) to the telephone network. In the United States, another major characteristic is that telephone companies are supposed to provide universal service to all households. Therefore, not only is a customer assumed to use telephone services regardless which carrier provides the service, but also a customer expects that the service will be available whenever the customer needs it. Customer attrition in telecommunications is termination of the existing contract with the carrier. When that happens, the service provider knows that this customer is going to defect and assumes that this customer will switch to another competitor for the telecommunications services. This type of attrition is called contractual attrition.

The passenger airline industry is different from the telecommunications industry. First, there is no contractual relationship existing between a customer and an airline for air travel services. Customers do not need to purchase an option to access the airline services. Customers can choose when to fly, where to fly, which airlines to fly, anytime, anywhere, all at their own free will and preference, without a binding contract. For example, a customer can walk into an airport, approach an airline ticket counter, and ask for a “stand-by” ticket. That means, whenever a flight to his/her destination has a vacant seat, he can buy the ticket and board the airplane immediately. On the other hand, an unexpected schedule change of a customer may lead the customer to change his/her flight, within the same airline or even to switch to another airline.

Furthermore, unlike the telecommunications or other public utility services, where the services are “on demand”, that is, they are available around the clock, customers' choice of airlines are constrained by the availability of flights to and from their destinations. In order for a customer to choose a certain flight, the airline's offering must match with the customer's preference. For example, a customer who resides in city A usually prefers to fly on airline S because he is a member of airline S's frequent flyer program. When he needs to fly from city A to city B, if airline S does not operate non-stop service on that market, this customer may then choose another airline operating non-stop service in that market. Of course, the hub-and-spoke network allows the customer to fly from city A to city C (another hub of airline S), then change flights to city B. But, that may take more time or require flights not in the customer's preferred time band. Under those circumstances, this customer might choose another airline for this trip. Does that mean the customer was about to defect? Not necessarily. He might come back to airline S for trips whenever the flights were “right”. Or he might defect if he found the other airline offers better services or better choices.

Another difference is that there is no assumption of universal service for air travel. In spite of increasing air travel volume, flying is still not considered the first choice of travel means for many people. In fact, there are other forms of travel, e.g., automobiles, buses, and trains, and so the elasticity of substitution for flying is usually high. There is also a substitution effect between telecommunication and airline. Along with the rapid expansion of telecommunication, the need for flying decreases. When a customer stops flying an airline, he may or may not “switch” to another airline. He may not need to fly as his job or business has changed and he may choose to drive because the traveling distance has been reduced or because driving is more convenient, e.g., he may choose to make a conference call instead of traveling to a meeting place. Reduction in flying mileage itself is not determinative of whether the customer is defecting or not. This type of defection can be called situational attrition. In situational attrition, because there is no contractual relationship between the customer and the supplier, the customer chooses their supplier based on their current need, the availability of the services, and other considerations specifically related to the situation.

Modeling retention for situational attrition is a much more challenging task to an analyst. The foremost question the analyst needs to answer is how to define defection? In other words, how to define the subgroup of the existing customers who still need the services, but are highly likely to change their service provider. There have been several approaches proposed for defining defection in the passenger airline industry.

Operational Definitions and Descriptions

Operational definitions use specific information from customer databases to determine categories for customers. The categories may include loyal customers and defectors. While such operational definitions may work, there are problems with them in an airline environment. Some of the possible definitions and problems are examined and discussed below.

One approach is to define retention based on the operational information available from airlines' operational and revenue databases. This approach distinguishes loyal customers from customers who used to be loyal but have demonstrated defection behavior. There are several possible definitions derived from this approach. Parameters P, Q, X, Y, and Z are used in these definitions and their values can be determined empirically through analysis of customer data, as follows:

P: the time period during which a steady flying pattern can be established to identify loyal customers (This should be a minimum of one to two years.);

Q: the time period during which different flying patterns can be observed to distinguish the defectors from the loyal customers (This should be a minimum of two years in order to account for seasonal patterns.);

X, Y: average monthly flying miles (or frequency, or revenue); and

Z: a predetermined percentage or measurement value.

The operational definition approach described above is summarized in FIG. 1. The following elements contribute to the operational definitions of loyal customers (retention) and defectors (attrition):

(1) Substantial Decrease in Miles Flown:

A loyal customer is one whose average monthly mileage traveled over the past P months was greater than X miles and for the consecutive Q months, this loyal customer's average monthly traveling mileage was at or above the X level.

A defector is a customer whose average monthly mileage traveled over the past P months was at or above X miles, however, for the consecutive Q months, this customer's average monthly traveling mileage had dropped below Y miles.

Furthermore, the magnitude of the dropping of the average monthly traveling miles from X to Y is considered “substantial” if it exceeds Z %.

(2) Gradual Decrease in Miles Flown:

A loyal customer is one whose average monthly mileage traveled over the past P months was greater than X miles and for the consecutive Q months, this loyal customer's average monthly traveling mileage was at or above the X level.

A defector is a customer whose average monthly mileage traveled over the past P months was at or above X miles, however, for the consecutive Q months, this customer's average monthly traveling mileage had dropped below Y miles.

Furthermore, the magnitude of the dropping of the average monthly traveling miles from X to Y is considered “gradual” if it is less than Z %.

(3) Significant Decrease in Flown Revenue:

A loyal customer is one whose average monthly revenue generated from air travel over the past P months was greater than $X and for the consecutive Q months, this loyal customer's average monthly revenue was at or above the $X level.

A defector is a customer whose average monthly revenue generated from air travel over the past P months was at or above $X, however, for the consecutive Q months, this customer's average monthly revenue had dropped below $Y.

Furthermore, the magnitude of the dropping of the average monthly revenue from $X to $Y is considered significant if it is greater or equal to Z %.

(4) Decrease in Frequency of Trips:

A loyal customer is one whose average monthly number of segments flown over the past P months was greater than X and for the consecutive Q months, this loyal customer's average monthly number of segments flown was at or above the X level.

A defector is a customer whose average monthly number of segments flown over the past P months was at or above X, however, for the consecutive Q months, this customer's average monthly number of segments flown had dropped below Y.

(5) Change in the Share of the Customers' Total Air Travel Expenses:

A loyal customer is one whose average monthly ratio of a measurement over the past P months was greater than X and for the consecutive Q months, this loyal customer's average monthly ratio was at or above the X level.

A defector is a customer whose average monthly ratio of a measurement over the past P months was at or above X, however, for the consecutive Q months, this customer's average monthly ratio had dropped below Y.

This ratio of share and the measurement of the customers' total air travel expense are undefined, and will depend on the availability of the external data.

(6) Change in the Customer's Elite Club Status:

Most frequent flyer programs establish elite passenger clubs, usually having several levels of membership, such as gold, silver, bronze. A customer may become a club member with a certain standing by cumulating respective mileage-points. These club members are evaluated by the airline periodically and anyone whose mileage-points have decreased is re-classified to a lower grade membership. This re-classification is used to identify an at risk customer when a continuing downgrading is found.

(7) Change in Travel Pattern:

During P months, a customer's pattern of flying can be determined by several measurements, such as revenue generated, routes flown, fare type, destinations, staying time, etc. Then, the same factors can be examined during the window period of Q months, or the same time frame of the previous year. The comparison of these factors may reveal a change in the customer's flying pattern. Combined with one of the above definition measurements, a possible defector may be identified. This is a broad definition that offers flexibility and the ability to accommodate to data; however, it may require substantially more customer data (such as external or socioeconomic data) and a better understanding of the customer.

The advantages of this operational definition approach are:

The definitions are derived directly from the airline's own operational data (except probably the definition 7);

The definitions are relatively easy to accommodate to the availability and changes of the data;

The approach takes into consideration the customers' historic pattern of air travel; and

The approach is thought to provide the direct measure of a customer's intention to defection from their current carriers.

However, this approach does not consider the unique characteristics of the passenger airline industry e.g., situational attrition as discussed earlier. A passenger's changing travel pattern for a prolonged period (time frame Q) can be caused by one or many of the following reasons:

Change of job or business need;

No available flights to or from the selected destinations offered by the airline;

Flights available from the airline do not satisfy the customer's preference;

Competitor's offers are better;

Other personal reasons; and

Customer intends to defect.

Therefore, simply observing the dropping of average monthly flying miles or revenue contributions may not warrant the conclusion that the customer is going to defect. In fact, one study has shown that, “Job has not required flying recently” and “Changes in Job/Responsibilities” are the two most important reasons for decreased or even stopped flying. Job-related changes account for over 60% of lost business. When the situation becomes “right”, the customer may very well continue to fly the same airline. From the customers' point of view, since there is no contractual relationship with the airline, there is no need for the customer to take deliberate actions, such as termination of service contract or not renewing the contract, to defect.

Unless the benefits associated with the continuing relationship with the same airline are so overwhelming, the customer probably always selects the most convenient, fastest and cheapest options.

Another problem with the operational definition approach is that this approach does not consider competitiveness in the marketplace. A defection is defined within a competitive market framework. When more than one supplier in the same market provides similar products and services and a customer who has been loyal toward one provider for a certain period of time chooses another provider for the same services, the provider who lost the customer will see that loss as defection or attrition. Obviously, the key is that the customers have choices and the competitive market provides the choices to the customers. In a monopoly market, the customers have no choices to select their service providers and therefore there is no attrition. The same is true in the airline industry. If for certain markets, only one airline operates in those markets, then the customers have no choice but to fly that airline. Even if more than one airline operates in certain markets, if for a certain date or time band, there is only one operating, then the customers still have no choice. As discussed before, most city-pairs in the United States have no non-stop service of air travel. For the customers to or from small or midsize cities, only a few airlines operate the short haul flights in those markets, and most of those flights are to feed the hubs. For example, a customer flying out of Ithica, N.Y., the only choice is currently USAir Express. USAir operates in those markets because historically it was a local carrier with an operation charter in those markets. The customer flying USAir Express may continue to fly USAir from one of its hubs to another hub. Is this customer a loyal customer to USAir? Maybe or maybe not. First, this customer has no choice, and second, since this customer has to fly USAir, he/she may join USAir's frequent flyer program to gain benefits and thus continue to fly USAir. We do not know what the customer will do if other airlines operate in the same market and offer competitive schedule and benefit.

In summary, retention modeling based on operational definitions of defection for airline industry target a population so heterogeneous that no unique behavior pattern can be identified and predicted. In addition, without a competitive market environment, no meaningful defection actions can be observed. Thus, there is a need in the art for an improved method of modeling customer retention for airlines.

### DISCLOSURE/SUMMARY OF THE INVENTION

It is therefore an object of the present invention to provide an improved airline customer retention modeling methodology.

Another object of the present invention is to enable airlines to improve customer relationship management.

The components enable the Passenger Carrier Airlines to effectively address “top-of-mind” Customer Relationship Management issues, such as, how to retain high-valued customers.

The solution components were developed based on extensive communications industry, data warehousing, and data mining experience.

The above described objects are fulfilled by a method of building a customer retention model. Data elements and data sources are identified. A data file format is laid out and statistical and analytical packages are identified. The statistical and analytical packages are applied to data from the data sources fulfilling the data elements identified in the data file format to perform customer retention. In an alternate embodiment, the method includes applying the statistical and analytical packages to data from the data sources fulfilling data elements identified in the data file format to identify customer for customer retention.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

Ideally, the Analytic Modeler uses the Teradata Warehouse, built from the Logical Data Model for an Airline as the model's data source. The data preparation process is likely to be simplified when the data is taken from the warehouse; however, a data warehouse implementation is not required.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a chart of an operational definition of customer loyalty;

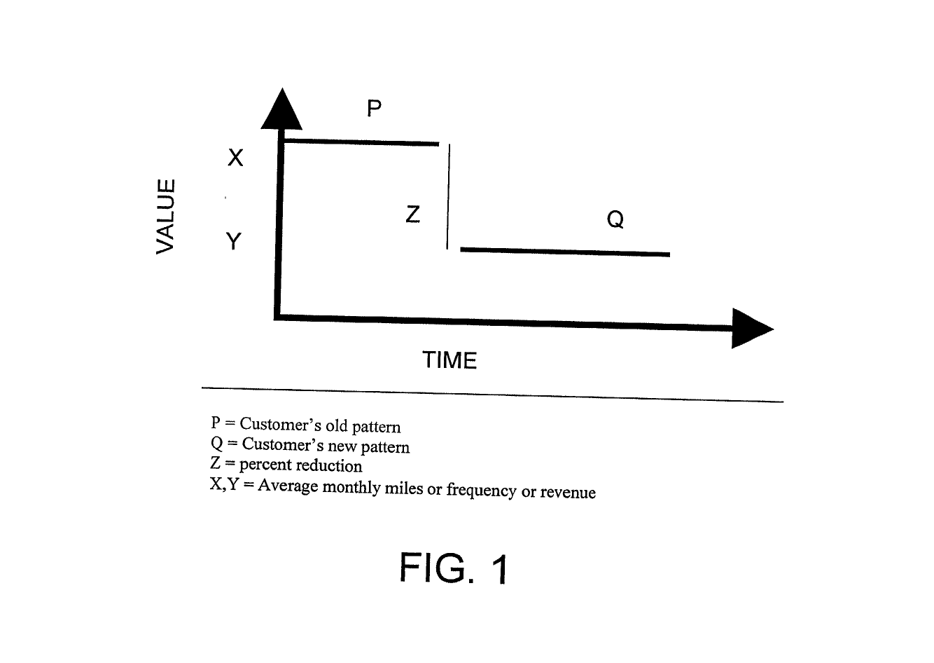

FIG. 2 is a high level chart of the predictive power of the retention model of the present invention; and

FIG. 3 is a high level diagram of an analytical modeling data structure used in an embodiment of the present invention.

### BEST MODE FOR CARRYING OUT THE INVENTION

A method and apparatus for modeling customer retention for airlines are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

The present invention described herein is related to, and forms a part of an acquisition and retention modeling methodology as described in copending applications, “An Acquisition Modeling Method for Airlines”, (Docket No. 8896 (3225-114) and “Logical Data Model for Airline Customer Relationship Management” (Docket No. 8904 (3225-118), both assigned to the present assignee and incorporated herein in their entirety by reference.

Customer Profile and Competitive Market Approach

Based on the characteristics of the airline industry and the competitiveness of the air travel market described above, an inventive approach to defining defection/attrition and thereby to defining retention is described herein. This approach is an improvement over the previous approach. The competitiveness and the situational attrition of the passenger airline industry is taken into consideration. This approach leads the retention models to target a much more homogeneous population within a competitive market environment and enhances the predictive power and accuracy of the retention models.

The competitiveness of the market means customers may select the airlines for their travel needs and implies that there may be competitive flights available to the airline instead of another is a loyal customer. If a particular customer's usage of an airline has dropped for a prolonged period, then this may be a customer “at risk” of defection.

To determine the competitiveness of the market, first we consider the market share of each major airline. The market share information is readily available. We want to consider customers who fly in markets neither dominated by a particular airline (for example, the client airline), nor negligible to that airline. Neither of those markets is considered competitive for our purposes. Another factor is the number of players in a market. If there are few players and each has a reasonable market share, then that market is highly competitive.

This consideration leads us to believe that the retention modeling efforts should concentrate on the few cities where a client airline has established hubs. Those hubs carry most of the traffic volume of the airline, both from a local market as well as from the spokes feeding the hubs. These hub-markets are:

Not dominated by only one airline;

Two or more airlines operating from the hubs;

The airlines offer competitive flights; and

The hubs pick up a large amount of traffic volume, both local customers and transfers from spokes.

In determining the target population of retention models, first, choose the members of the frequent flyer programs. The frequent flyer program provides not only most of the high valued customers but also more complete data. Then, from the frequent flyer customers, the high valued customers are selected based on a Customer Value Model. Studies of the U.S. airline industry show that less than 20% of the high valued customers contribute over 50% of the revenue and a significant portion of profit to airlines. Therefore, retaining a high valued customer makes significant contributions to an airline's profit margin. Thus, high valued customers flying out of a predetermined competitive hub are selected.

Then, customers' profiles are established, particularly their travel patterns. The travel patterns are identified by several factors, such as O&D, travel time (departing and returning time), staying time, number of legs of trips, booking channel, service class, etc. Unlike the seventh definition mentioned above, it is not believed that changing the travel pattern itself will help define the defection. A changing travel pattern is more of an indication of a changing customer's travel need. How this changing travel need affects the customer's choice of airline depends on the surrounding situations and market conditions. For example, a customer may continue to fly the same airline even though his/her destinations have changed. A customer may switch to another airline even though his/her destinations have not changed but only the departing time has changed. Under those circumstances, a closer look of the flight data may reveal that in the customer's new time band, the client airline does not offer the flights that he/she prefers; therefore, this customer has no choice but to switch to another airline offering the preferred flight. By choosing the high valued customers in the competitive hubs, it is assumed that the client airline has the capacity to serve the customers and offers flights to meet the customers' needs. Therefore, a customer drastically reducing his/her usage of the airline is highly likely to switch to a competitor, given that there is no major change in the customer's socioeconomic condition.

According to this approach, the criteria for a loyal customer are defined as the following:

The customer has shown a steady trend of flying the client airline for a predetermined length of time;

The customer chooses the client airline in a competitive market environment;

The customer chooses flights operated by the client airline when there are competitive flights available; and

Since the airlines pay much attention to the members of their frequent flyers programs, we assume that the loyal customer should be a member of those programs.

Consequently, customer attrition is defined as:

The customer used to be a loyal customer;

The customer still flies in a competitive market;

The flights operated by the client airline are still available to the customer;

The customer may still keep his/her frequent flyer program membership;

The customer drastically reduced his/her usage of the client airline.

Of course, the usage can be measured by the operational measurements discussed above, e.g., variables P, Q, X, Y, and Z.

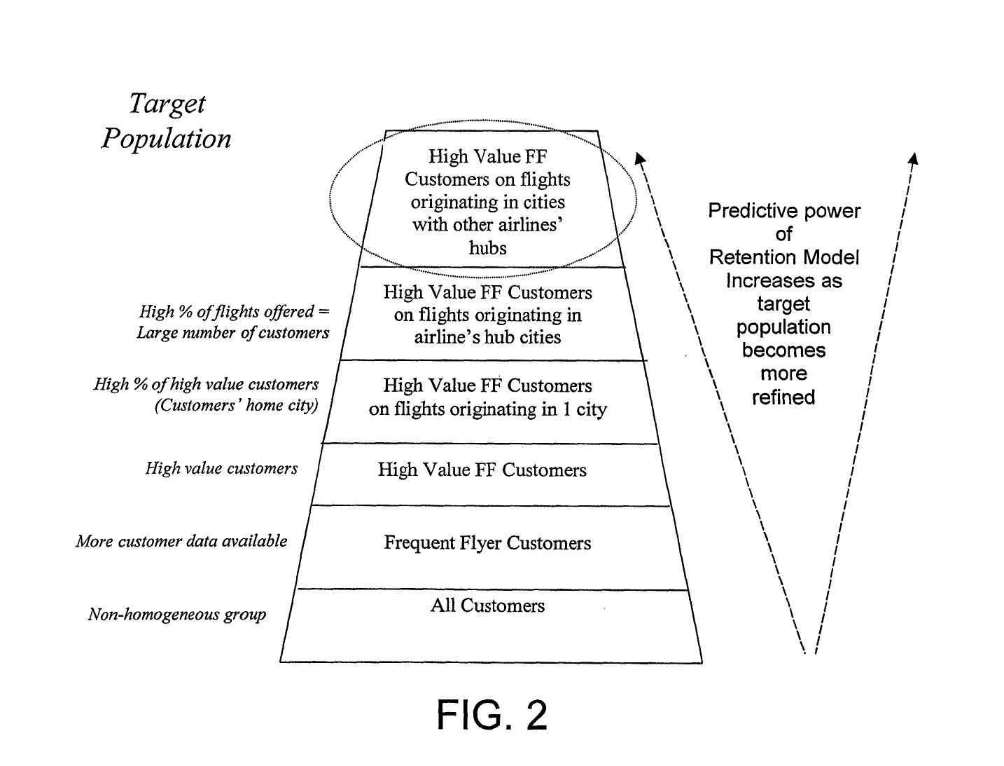

This approach can be summarized in FIG. 2 showing that as the homogeneity of customers increases by concentration on a sub-group of the total population, the predictive power of the retention model increases.

Defining the Dependent Variable

Once the business question of what to model is clearly defined, the next step is to define the analytical model's dependent variable. The retention model described in this document applies to customer level data. The dependent variable for the model reflects the customer's decision to continually fly the same airline or switch to another airline. This dependent variable needs to be derived from data when:

A high valued customer base is obtained;

Loyalty measurement of customers has been established; and

Customers' attrition/non-attrition behavior can be identified, based on the defection definition discussed supra.

Historical information on customers' air travel patterns is provided. A customer, who in period P flew in markets where there is sufficient competition in similar flights on the same routes, who has stopped or significantly reduced the flying of the same airline for period Q, is defined as a defection. In addition, the customer has not been flying in other market segments. The latter information shows that the customer's travel need has not changed.

The possible causes for defection are independent variables and are derived from the data. The dependent variable field is coded 1 for the attrition customer's record; otherwise dependent variable the field of the customer record is coded 0. This binary variable is the dependent variable of the retention models.

For example, a customer who is a member of a frequent flier program usually flies round-trip from Newark (EWR) to Baltimore-Washington International Airport (BWI) or Atlanta (ATL) for the months from January to December of 1998. The markets he flies are highly competitive, which means there are several airlines available for selection. Examination of data further reveals that he usually flies in the flights departing from EWR in the morning and stays for a couple of days, then flies back in early afternoon flights. He purchased tickets through a travel agency, usually with only one-week advanced booking, and thus paid full fare. The Customer Value model, more fully described below, indicates that this customer is a high valued customer. However, recent data shows that for the months of January to June of 1999 (the window period), there are no records of the customer flying on the same airline (the client airline). If external data is available, the data shows that there is no change of job or address. All these factors indicate that the customer is highly likely to defect. Thus, the attrition field of the customer record is coded or set to a value of 1.

Dependencies

Typically about 60 to 80 percent of a retention analytical modeling project is spent on data preparation. For the airline industry, which has a tremendous amount of operational data, building analytical models without a data warehouse is a very difficult, if not impossible task. At any rate, decisions about data sources, locations and availability should be solved at the beginning of the analytical modeling project. This is accomplished through in-depth discussions between modelers and client airline personnel possessing the appropriate knowledge. It is assumed that the client is prepared and provides the necessary (internal, transactional) data, at some agreed upon levels of summation, in a mutually acceptable form. It is recommended that analytical modeler/analysts and project managers do the following:

Provide the list of data elements (i.e., customer and operations data elements model output data, and other desirable data) that may be needed for building retention models. If a data warehouse (DW) is installed, the data elements will be drawn from the DW;

Engage in discussions with the client's personnel to identify possible data sources;

Discuss the possibility of including external data; and

Lay out the data file format.

The following are prerequisites for a modeling engagement:

Determine the location and availability of data sources;

Decide which data sources (internal and external) will be used;

Agree on defined data format is;

If a DW is installed, the above are part of the DW efforts;

Client airline personnel are prerequisites;

Responsibility for data source availability is defined.

Responsibility for providing insight on the data is defined; and

Acquire statistical and analytical packages.

In summary, if a DW is installed, the analytical modelers will rely on the DW as the data source; otherwise, the analytical modelers obtain data from the original sources. The more detailed data preparation process is discussed below.

Customer Value Metric Model

Customer valuation is a very important issue for all airlines. When airlines want to pursue either retention, acquisition or business growth, the foremost task is discovering who are the in most valuable customers. A sound methodology is required to help airlines solve this problem.

The following describes the definitions of customer value and the methodology used to develop a Customer Value Metric Model (CVMM). This model ranks passenger data and identifies the most highly valued customers for the carrier. The customer valuation model is not a Recency-Frequency Model, commonly known as RFM. The CVMM provides a much more sophisticated and balanced methodology to score customers and is carried on with or without retention modeling.

Defining Customer Value

Airlines are genuinely interested in finding high valued customers as described in detail above. The question is what are the criteria that carriers may use to define customer value? Criteria in the present invention include recency (time period), frequency (mileage), and revenue (profit). It is not, however, the standard RFM model with which many are familiar. The model described below presents a more sophisticated approach to the problem of defining value.

As discussed previously, while the airlines' profit margin is generally low, the marginal cost of adding one more passenger to an aircraft is also very low due to the economies of scale of the aircraft. Each airline has its so-called break-even load factor. That is the percentage of the seats that the airline must sell at a given price (yield) to cover its costs including operational costs, airport fees, commissions paid to travel agencies, and other costs. Given a revenue level, lower costs, result in a lower break-even load factor. Even though revenue and costs vary from one carrier to another, on average the break-even load factor is about 65% for the airline industry.

Most airlines operate very close to the break-even load factor. Therefore, the marginal revenue earned from the sale of one additional seat on each flight contributes significantly to the airline's profitability. Frequent flyer programs are used commonly in the airline industry to attract passengers. An industry wide study has shown that frequent fliers not only contribute significantly to airlines' revenue and profit, but also make up a large portion of the passenger traffic volume. Passengers taking more than ten trips a year, though accounting for only 8% of passenger population for a given year, contribute about 45% of air travel volume. This fact tells the airlines that those customers are the most prized ones. Obviously, the customer valuation model needs the ability to identify these customers. Thus, one criterion used in the CVMM for high valued customer is flying frequency.

Another criterion is the revenue contributed by the customer. As discussed before, a passenger paying full-fare is more valuable than a passenger paying a deeply discounted price, even though they may sit next to each other in the same section of a flight. The airline pricing policy distinguishes between these two types of customers. The revenue measure is the ticket price minus the airport fee, commission, and certain taxes, but not the operational cost. Operational cost on average, in terms of per seat/per mile, is more or less a constant across the airline and is not considered, thus simplifying the task.

Another revenue-related measurement is flying mileage. From a revenue management point of view by the carrier, by flying more miles, the customer generates more revenue.

These three measurements together create many possible combinations. Among them, revenue contribution is the most important, while the other two, (i.e., frequency and mileage, are complementary factors). For simplicity, revenue contribution in combination with either one of the other two measures is used as a classifier.

These criteria give a three-tiered structure of customer value as shown in Table 1 below:

TABLE 1
High Frequency(Mileage)/High Revenue Contribution

| | |
|---|---|
| High Frequency/Low Revenue Contribution | Low Frequency/High Revenue Contribution |
| High Mileage/Low Revenue Contribution | Low Mileage/High Revenue Contribution |

Low Frequency(Mileage)/Low Revenue Contribution

Of course, the third tier customers, Low Frequency (Mileage)/Low Revenue Contribution, will not be the ideal target of the predictive model, while the first tier customers are the most valuable customers for airlines. The problem is the customers in the second tier. Are they also valuable customers? How does an airline deal with these groups?

Airlines may want to retain the Low Frequency (Mileage)/High Revenue Contribution customers for obvious reasons. However, those customers may not be so loyal to the airline because the benefits they receive from frequent flyer programs are not significant enough to keep them flying the same airline.

On the other hand, the High Frequency (Mileage)/Low Revenue Contribution customers may be loyal to the specific airline because of the benefits from the frequent flyer programs, but their marginal contributions to the profitability of the airline is low. Airlines may want to keep these customers only because they hope that these customers may eventually generate additional revenue. Along with more affinity programs that airlines have established with credit card companies, hotel and car rental companies, even long distance telephone companies, some customers may be able to accumulate high mileage points without contributing any revenue to the airline. These customers need to be identified.

Developing a Customer Value Metric Model (CVMM)

Data Requirements

As discussed above, a customer's value is measured by the customer's contribution to the carrier's profit. The following data elements are essential:

Passenger frequent flyer program membership information;

Most recent passenger flying data (including departing/arrival airports, flight numbers, distances flew, etc.);

Booking channel data;

Ticking data, gross revenue, and fees paid; and

Costs.

These data elements are part of the airline's database. Passengers referred to here are members of the frequent flyer programs.

Recency Group and Flight Frequency

The recency group includes passengers who have flown the airline within the airline specified recent time period, for example, in the past six or twelve months. These are active passengers for the time period under consideration and the flight activities of the passengers, who are members of the frequent flyer program, is summarized for that time period.

Flight activities are defined as any revenue generating flights actually flown during a specified period of time. Each flight activity is measured by a one-way, end-to-end trip. For example, a flight from National Airport in Washington, D.C. to New York's JFK International Airport, is counted as one flight activity. A flight from Newark Airport to Los Angeles, via Cleveland, is counted as one flight activity, even though the passengers need to unboard the airplane at the Cleveland airport and board another flight to Los Angeles. On the other hand, if the flight from Newark to Los Angeles is a non-stop flight, then this flight is also counted as one flight activity. The flight activity information is available from the passenger ticket reservation system data as well as from the flight data of the airline. The counts start from the origination airport and end with the destination airport. All major airports have a unique code.

A summary of all the flight activities within the specified time period for each passenger is the frequency value of the passenger. Reward flights may be included in the database and are counted for frequency value and the net revenue calculation considers this situation.

A summary of the mileage flown in the recency period is a straightforward calculation, obtainable directly from flight activity data.

Revenue Contribution

The next step is to calculate the passenger's revenue contribution to the airline. The gross revenue contribution is a summary of the revenue per passenger per flight activity and is the ticket price the passenger paid for each leg of the trip or the entire trip.

Cost Factors

The costs associated with that flight activity should be subtracted from the gross revenue contribution. The following are cost factors:

Domestic/International ticket sales costs: sales channels can be divided into several categories, such as sales through airlines Computerized Reservation System (CRS), or paperless e-ticket, or paperless, web-ticket. The costs/fees of each sales channel may be different. These costs should be subtracted from the gross revenue contribution.

Travel agent commissions: in addition to the above sales costs, if the ticket issued by a travel agent, a certain percentage of the ticket price should be deducted for commission. If the ticket was issued by another airline, a certain percentage of fees also needs to be deducted.

Airport Fees: airport landing fees are a significant portion of the airline's costs. These fees need to be deducted from the gross revenue.

Meals/Beverages: costs of meals and beverages should be subtracted from the gross revenue contribution. However, if the flight activity is a reward trip, then these costs need not be subtracted, since the costs are embedded in the cost of miles.

Taxes: certain taxes paid by the airlines should be deducted.

Those costs are usually either shown on the sales of tickets, or calculated through carrier specific formula or percentages. As discussed above, the operational costs are not considered here.

If the reward flights are included, then the cost of frequent flyer miles needs to be deducted from the gross revenue. Each airline may have their own formula to calculate the cost of rewarded miles. Certain specific rates may associate with specific reward redeemed. For a frequent flyer program, accumulation of miles is not a cost, but redemption of the frequent flyer miles is a cost. For a free upgrade, the lost revenue may be calculated using an airline-specific formula.

Net Revenue Contribution

Once the revenue and all costs are calculated, the difference of the gross revenue contribution and the overall costs is net revenue contribution. This is a dollar value measurement for each passenger's contribution to the airline's bottom line, (i.e., the airline's profit margin).

All flight activities, frequency value and net revenue contribution data are summarized at a passenger level for the recency period. That is, each member of the frequent flyer program should have a unique account followed by other fields that contain all other information.

Scoring Method

Scoring for the CVMM uses frequency value and net revenue contribution value in a common procedure to rank and score the customer values. After obtaining frequency values (FV) and net revenue contribution values (CV) for the passengers of the recency group, the two values are scored. The purpose of scoring is to identify the group of passengers who are high frequency flyers and high net revenue contributors. There are several possible ways to divide and score the data, a preferred approach is to divide the entire data into four subgroups. A similar method can be used to divide the entire data into deciles or any number of subgroups.

Frequency Value Scoring

Sort the FV by descending order;

Determine the 75%, 50% and 25% break points; i.e., divide the entire population into four quartiles, each break point corresponds to a frequency value, for example, at the 75% break point, the FV is 25, at the 50% break point, the FV is 12, etc.;

Move the break points when there are ties: for example, if the 75% observation is 3,000^{th} record, and its FV is 25, but the 3,001^{th} has the same FV, then go down the list, until the FV changes its value. That observation would be the break point. Apply the same method to the entire data to determine the break points. The entire population may not be evenly divided when there are ties at the break points; and

Assign integer values to each of the sub-groups. For example, assign 4 to the records above the 75% break points, 3 to the records between the 75% and the 50%, 2 to the records between the 50% to the 25%, and 1 to the records below the 25%. These are Frequency Scores (FS).

Net Revenue Contribution Scoring

Apply a similar method to determine the 75%, 50% and 25% break points for Net Revenue Contribution Value (CV), then the same integer values (4, 3, 2, 1) will be assigned to each quartile. Those 4 integers are the scores of the FV and CV series. These are Contribution Scores (CS).

CVMM Scoring

After scoring for both CV and FV, sort the entire data by the scores-pair series (CS, FS) in a descending order.

The possible pairs are (4, 4), (4, 3), (4, 2), (4, 1), . . . (1,4), (1,3), (1,2), and (1,1).

For the records with the same pair, sort by CV. For example if both records have (3,2), but one's CV is $2,000, another's CV is $1,850, then the one with CV of $2,000 is above the one with CV of $1,850 in sorting.

If the records still have the same CV, then sort by FV. For example, for the records having the same scores-pair (3,2), if they both have the same CV of $1,680, then sort them by their FV. The one with a higher FV will then be ranked higher than the one with a lower FV.

When all the records have been sorted by their (CS, FS) score-pair, divide the entire population into 100 subgroups. Give each record within a subgroup a numerical value from 100 to 1. Those records with the highest 1% of scores are assigned a value of 100; the next 1% are assigned a value of 99. This process continues until the lowest 1% is assigned a value of 1. These assigned numerical values are called Customer Value Metric Scores (CVMS).

The passengers with high CVMS are the High Valued Customers.

Table 2 is a result of applying the above process to actual airline data.

TABLE 2

| Customer | CV | FV | CS | FS | CVMS |
|---|---|---|---|---|---|
| 1 | 850 | 2 | 4 | 1 | 82 |
| 2 | 682 | 1 | 4 | 1 | 82 |
| 3 | 450 | 4 | 3 | 3 | 72 |
| 4 | 503 | 3 | 3 | 3 | 74 |
| 5 | 122 | 6 | 1 | 4 | 61 |
| 6 | 159 | 5 | 1 | 4 | 60 |
| 7 | 1263 | 5 | 4 | 4 | 91 |
| 8 | 2202 | 6 | 4 | 4 | 94 |
| 9 | 510 | 5 | 3 | 4 | 79 |
| 10 | 180 | 4 | 1 | 3 | 53 |

First, this method handles tier 2 customers subjectively. According to the above table, a (CS, FS)=(4,1) pair always has a higher score than any (1,4) pairs. That is, low frequency flyers with a higher net revenue contribution are always ranked higher in customer value than those with higher flying frequency but lower revenue contributions. In the above table, customer 1's CVM score (82) is much higher than customer 6 (60) only because it has a higher CV even though customer 1's FV is much lower (2 vs. 5). This shows that the ranking of a customer's value is determined by the sorting procedure. It may be biased when ranking the customers in second and fourth quadrant.

Second, because tied pairs are sorted first by CV and then by FV, this ranking procedure may cause a biased ranking. Looking at customers 3 and 4, for example, since they are the same group (3,3), they are first sorted by CV, and then by FV. After sorting, customer 4 obtains a higher score (74) than customer 3 (72), even though customer 3 flies more frequently than customer 4. It is not a big problem in this case because the difference between their CVs is relatively small. However, depending on the data size and scoring sensitivity, for a very large database, a little scoring difference may affect a lot of customers' values. In summary, since this method considers the combination of CV and FV, it is a challenge to balance the weight or rank order of the two values.

An alternative method for alleviating bias is either to calculate (a) a ratio of CV/FV, or (b) a multiplication of CV*FV. CV/FV results in a CV per FV, but the problem with this method is a high CV with a low FV, such as when FV equals 1, is ranked higher, e.g., customer 2 in the Table 2 above. CV*FV is actually a CV weighted by FV, or an index of customer value; however, CV*FV may change the entire ranking from the above procedure. For example, when applying the multiplication to the above table, the ranking becomes customer 8 as the highest, then customer 7 as the second and customer 9 as the third. The (4, 1) pair, (i.e., customer 2) is now ranked lowest. This method seems to give a relatively balanced ranking of customers' values.

Alternative Methods for CVM Scoring

Alternative methods to calculate the CVM scores are now described. The methods consider CV as the primary measurement for customer value, and FV as the desired complementary factor.

Procedure One

The first procedure is as follows:

1. Calculate the multiplication of CV*FV;

2. Sort based on the calculated value.

3. Segment the entire CV*FV series into 100 subgroups.

4. Assign values to each subgroup (100 for highest 1%, 99 to next 1%, . . . , 1 to lowest 1%) as stated before;

5. The assigned values are the CVMSs.

According to this method, Table 2 above will change to Table 3 below:

TABLE 3

| Customer | CV | FV | CV * FV | CVM Score |
|---|---|---|---|---|
| 8 | 2202 | 6 | 13212 | 94 |
| 7 | 1263 | 5 | 6315 | 91 |
| 9 | 510 | 5 | 2550 | 79 |
| 3 | 450 | 4 | 1800 | 72 |
| 1 | 850 | 2 | 1700 | 82 |
| 4 | 503 | 3 | 1509 | 74 |
| 6 | 159 | 5 | 795 | 60 |
| 5 | 122 | 6 | 732 | 61 |
| 10 | 180 | 4 | 720 | 53 |
| 2 | 682 | 1 | 682 | 82 |

Table 3 results indicate that even though the CV*FV scores give a ranking mostly consistent with the previous CVMS method, customer 2 with significantly lower FV is now ranked at the bottom. Another observation is that although customer 3's CV is lower than customer 4's, customer 3 is ranked higher because of the FV score. This shows that the difference in CV between the two customers will not offset the difference in their frequency of flying.

Procedure Two

Procedure two further considers a more appropriate weight using frequency values.

1. Sort based on CV, if there are ties of CV, then sort by FV, in descending order;

2. Determine the 75%, 50% and 25% break points and assign a value, e.g., integers 1-4, to each quartile;

3. Calculate the average FV for each quartile;

4. If the mean of FV for each quartile is significantly different (using certain statistical procedures such as t-test), then calculate the ratio of each FV vs. its quartile mean;

5. Use these ratios as weight to calculate CV*(FV weight). This value is called CVFW and is the CVM score.

This method or procedure gives us a weighted index of CV. Each CV is weighted by its FV weight. FVs higher than the group mean have a weight ratio greater than 1 and FVs lower than the group mean have a weight ratio less than 1. This procedure gives better-balanced scores to high CV, high FV customers.

Procedure Three

The third procedure uses mileage value (MV) instead of FV to weight the CV. Procedures similar to those discussed above are followed to calculate a mileage-weighted CV.

1. Sort by CV. If there are ties of CV, then sort MV, in descending order;

2. Determine the 75%, 50% and 25% break points and assign 4-1 values to each quartile;

3. Calculate the average mileage for each quartile;

4. If the mean of mileage for each quartile is significantly different, then calculate the ratio of each customer's mileage vs. its quartile mean; and

5. Use these ratios as weighting to calculate CV*(mileage weight) and call it CVMW.

Using flight mileage is more appropriate for several reasons. First, airlines always consider flight mileage as an important indication of customer value. This exactly why airlines have frequent flyer programs and each member of those programs earns points based on the miles they have flown (not the frequency value). Second, flight mileage is a more accurate measure of flight activities. In our example, a flight from Newark Airport to Los Angeles, can go via Cleveland, or can be a non-stop direct flight. In either case, FV will be count as 1, but CV will be different and so will flight mileage. A non-stop flight from Newark to Los Angeles may be more expensive, but less flight mileage than the non-direct flight. The value offered by the non-stop flight is time savings as discussed above. A customer flying a non-stop flight and paying a higher fare is a highly time sensitive customer, e.g., usually a business traveler. The frequency values do not reflect this difference in customers. A combined measure of CV and mileage captures the nature of flying activities and thus distinguishes the high valued customers from the rest.

The process to obtain and prepare the data from which the model is developed is now described.

Data Elements—Describes the data elements necessary to execute data analysis and then build analytical models. This section defines customer, sales channels, and travel agent data, as well as airline operational data that is critical for a successful analytical model. Data element tables are shown in Tables 4-6 below, as well as a notation key table provided in Table 7.

Table 4 lists those data elements that are important customer and operational data. These are elements that are needed for the models described in this document. The table indicates probable source, importance of the element, and how the element appears in the logical data model for airlines.

TABLE 4
Customer and Operations Data Elements

| Data | | Importance | Mapping |
|---|---|---|---|
| Source | Data Element | to Model | to LDM |
| IC | Customer ID (Frequent Flyer ID) | V | Yes |
| IC | Customer Address, Phone Number, Zip Code | HD | Yes |
| IC | Contacting Records | V | Yes |
| IC/IO | Flight Data: O & D, Time, Legs, Route, Actual Mileage | V | Yes |
| IC | History of the Customer | V | Yes |
| IC | Service Class | D | Yes |
| IC | Member Status | HD | Yes |
| IC | Booking | HD | Yes |
| IC/IO | Travel Agency Code/Location/Type | HD | Yes |
| IC | Cumulated Mileage/Points | V | Yes |
| IC/IO | Gross Revenue Contribution | V | Yes |
| IC/IO | Tickets | V | Yes |
| IC/IO | Checking-in | HD | Yes |
| IC/IO | Customer Canceled Flights | HD | Yes |
| IC/IO | Coupon Revenue | V | Yes |
| IO | Costs (or formulas, percentages to allocate certain costs items) | V | NO # |
| IC/IO | Baggage: Missing/Mishandled | HD | NO ## |
| IO | Flight Incident: Delay, Canceled, Changed Route, | V | Yes |
| IC | Customer Complaints | V | Yes |
| IC/IO | Reward Flights | HD | Yes |
| EC | Customer Profile (1): Occupation, Employer/Employment History | V | Yes* |
| EC | Customer Profile (2): Annual Income, Credit Ranking/History, | V | Yes* |
| EC | Customer Profile (3): Education, General Household Data | HD | Yes* |
| EC | Customer Profile (4): Travel Related-rental car, hotel, credit card | HD | Yes* |
| EC | Customer Profile (5): Lifestyle | HD | Yes* |
| EC | For Business Owner: Business Type, Annual Revenue, | HD | Yes |
| EC | Home Business Indicator | HD | NO** |
| EC | Business Credit Rating | HD | Yes |
| EC | State | 0 | Yes |
| EC | Zip code/Postal code | 0 | Yes |
| EC | Metropolitan Statistic Area or Geographical Specific Data | 0 | Yes |
| EC | Area Population | 0 | Yes |
| EO | Market Share | V | Yes |
| EO | Published Scheduling(all airlines for the selected hubs) | V | Yes |
| EO | Actual Scheduling(all airlines for the selected hubs) | V | |
| EO | Hub Capacity(number of flights, Enplanement) | HD | NO |
| EO | Competing Hubs Operated by Other Airlines | HD | Yes |
| EO | Airline Service Quality Performance | HD | Yes |

# These percentages or formulas will be used in the Customer Value Model. The exact definition is expected to client specific.
## Baggage data will be available in the future release of the Solutions.
*Customer Profile Groups can contain any number of informational items about a customer, that could be mapped to Customer Specific area in the LDM. However there is no guarantee that a client will have the information or even a data source from which to populate.
**This data will be provided by an external vendor. It maybe possible to track “Home Business” using the Customer Profile data structures.
***The client airline's actual scheduling data is covered in the flown flight data area, which is an internal data item. Other airlines' flight data is an extemal data item.

Table 5 lists additional data that may be useful for a retention model. This data may help provide insight into customer satisfaction issues, but is not directly used in the models described in the document.

TABLE 5
Other Desirable Data

| Data | | Importance | Mapping |
|---|---|---|---|
| Source | Data Element | to Model | to LDM |
| I | Price Modifications/Discounting Policy | HD | Yes |
| I | Customer Complaints Processing Procedures and | HD | Yes |
| | Standard | | |
| I | Customer services standard - quality, response time, | HD | Yes |
| | etc. | | |
| I | Customer satisfaction measurement | HD | Yes |
| I | Any measures encouraging customer loyalty | HD | Yes |

Table 6 lists data elements that are output from the model. These are usually the scores attached to a customer record as a result of the analysis performed by the model. These scores allow the airline to rank customers based on their contribution, their likelihood to defect, etc. The scores are usually used to help target a population for a marketing campaign or for special treatment by the airline.

TABLE 6
Model Output Data

| Data | | | Mapping |
|---|---|---|---|
| Source | Data Element | Explanation | to LDM |
| MO | Customer ID | Unique primary key for customer | Yes |
| MO | Customer Value Score | Score for customer value (revenue) | Yes |
| MO | Retention Score | Score indicating probability of | Yes |
| | | retention | |
| MO | Multiplication of Customer Value | Derived variable | Yes |
| | Scores and Retention Scores | | |
| MO | Target Indicator: At risk customer | Indicates customer is target of | Yes |
| | indicator | campaign | |
| MO | Decile | Decile of population in which | Yes |
| | | customer is classified | |

In the table below, the following codes are used to indicate importance of the data element and probable sources for the data element.

TABLE 7
Importance and Data Source Notation

| | | |
|---|---|---|
| Importance to the model | V-vital | |
| | HD-highly desirable | |
| | D-desirable | |
| | N-of questionable or no value | |
| Data Sources | I-internal | From customer's database |
| | IC-internal about customers | Information about customers (name, address, |
| | | FF number, miles flown, etc.) |
| | IO-internal about operations | Information about operations (flight, |
| | | schedules, routes, costs, etc.) |
| | E-external | Information from the public sector or from |
| | | private vendors of data |
| | EC-external about customers | Information about customers (name, address, |
| | | mortgage, income, number of cars, etc.) |
| | EO-external about operations | Information about operations (markets, total |
| | | flights in a given market, total dollars spent on |
| | | tickets, etc.) |
| | MO-Model Output | Output from the analytical model |

Internal Data Sources—Describes the internal operational data sources including customer-base data, revenue management, flight scheduling, sales channel, and travel agency data, etc.

External Data Sources—Includes business and other socioeconomic data provided by private vendors, and public data sources.

Data Extraction—Provides descriptions of the following data extraction tasks:

Map the data;

Extract data from all data sources;

Clean and condition the data; and

Create the analytical data file.

Data Elements

To successfully execute data analysis and build analytical models, one must know the data structure and the data elements. A modeler involved in an airline industry engagement is aware of the data areas described below. The data elements for building analytical models is described next and there is no description of the entire data warehouse.

The airline provides its operational data, both current and historic data. In addition, certain external data is acquired, as the client desires. The data areas and critical data elements, as shown in Tables 4-6, are described next.

If a data warehouse exists for the carrier, then the analytical modelers rely on the DW to obtain the data elements (at least from internal data sources). Otherwise, the modelers obtain the data directly from the carrier's data sources. The modelers may have to rely on the carrier's database management system (DBMS) to provide the needed data, but of course, this adds cost and extends project time.

It is important for the analysts and project managers to know that, since the airlines' internal data sources may reside in different legacy systems and be managed by different departments, the data may not exist in a usable way and the data integrity may be poor. The matching rate for external data is sometimes low. The poorer the condition of the data, the more costly and time consuming is the project.

Another point worth mentioning is that all internal data sources are secured and may be extremely difficult to access the data if there is no DW. Therefore, a virtual DW or staging area architecture may be necessary.

Basic Data Structure

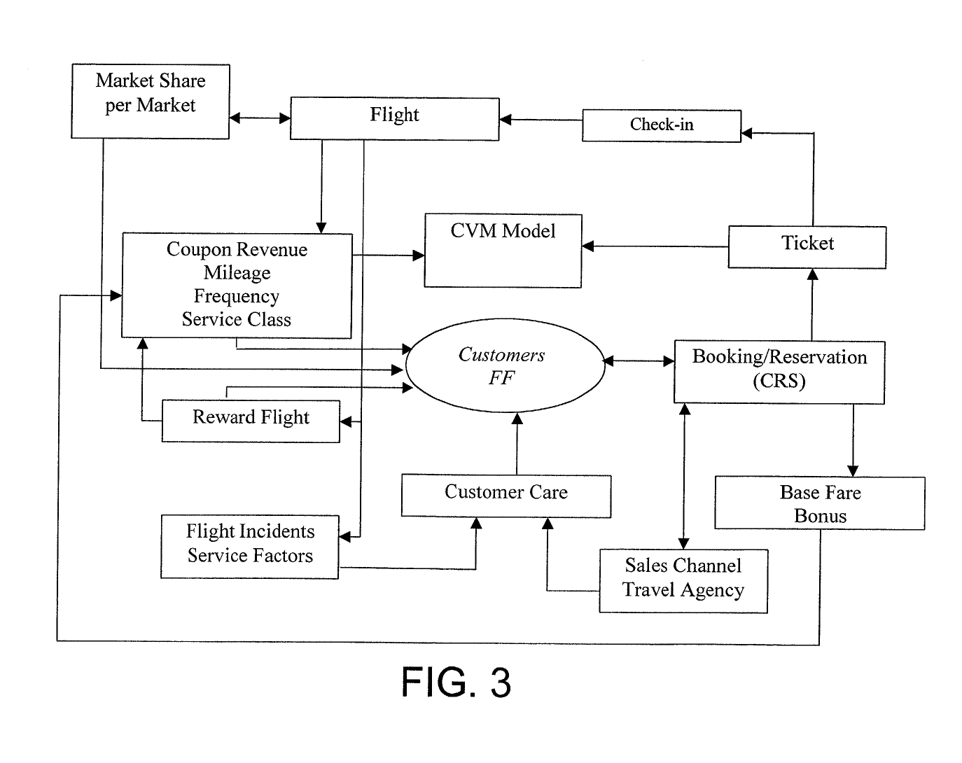

The basic data structure for analytical modeling is described below with reference to FIG. 3. The data structure described here is for analytical modeling only and does not cover the entire data warehouse, nor is it a substitute for the logical data model (LDM). The LDM for Customer Relationship Management is described fully in co-pending application entitled, “Logical Data Model for Airline Customer Relationship Management”, and is hereby incorporated by reference in its entirety.

Customers FF 302: the oval area in the center of the figure represents the customers who are members of the airline's Frequent Flyer Program. They are the target population for the retention models.

The CVM model 304 ranks these customers and identifies the high valued customers.

Customer Care 306 provides information about the customers' experience with the airline and its services.

Booking/Reservation 308. The customers start with the booking and reservation system when they purchase their tickets. They become revenue-generating customers only when they actually board the airplane (check in).

Flights 310 are the product airlines offer to the customers and are the source of revenue. The flight data provides customer's revenue contribution, mileage, and frequency, as well as destination, route, and other information.

Flight incidents and service factors 312 determine whether the customers are satisfied with the products and services supplied by the airline. These experiences influence a customer's selection of carriers.

One-way arrow lines in FIG. 3 indicate one-way flow of information, while two-way arrows indicate two-way flow of information. For example, flight data 310 provides information to reward flights 314: (i.e., a one-way flow of information). On the other hand, customer data or customer FF 302 provides input to CVM model 304, but CVM model will feed back to the customer data with the ranking results, (i.e., a two-way flow of information).

The Data Elements are Now Described in More Detail.

Customer FF 302: The purpose of retention models is to help the airlines retain their most highly valued customers. Customer FF 302 means customers of frequent flyer programs. These customers are the target population of the airlines' retention efforts. All other data elements must be able to link back to this data element, directly or indirectly. This data element provides information about who the customers are and where they are, and includes the following additional data elements:

Customer Base: basic information about a customer—CustomerID, name, address, etc.;

Contacting: how did the customer get contacted?;

Reward: the customer history of earning reward points and bonus;

Profile: what does the customer look like—occupation, education, other socioeconomic elements;

Segmentation: customer segmentation, how do they behave according to certain criteria;

Customer Life Cycle: the history of the customer and events in this duration; and

Customer Status: an active or inactive customer?

CVM Model 304: As discussed, the Customer Value Metric Model ranks the customer based on their Net Revenue Contribution, mileage and frequency values. This model identifies the sub-group of high valued customers. CVM Model data includes:

CustomerID;

Recency Period-the time span to determine the customer value;

Customer value measures—revenue contribution, frequency, and mileage flown; and

Ranking scores.

Customer Care 306: Unsatisfied customers are very likely to change their air travel carriers whenever they are able to do. Customer care data provides information on the relationship between a carrier and customers. The customer care data elements about the airline's response to customers influence the satisfaction level of customers and consequently influences their decision to select the airline. Customer care includes the following data elements:

Customer Care Base: Information about customer contacts, calls received, complaints and complements, airline response, etc.;

Flight Incidents: One major input to customer care is a flight incident including flight cancellation, delay, missed flight, changing of route, changing of flights or carrier, etc.;

Service Factor: Another important input to customer care is service quality, including increases in fare, changes in frequent flyer programs, airport services, connection services, baggage services, etc.; and

Sales and Travel Agencies: The reservation and booking process affects a customers' experience of air travel.

Booking and Reservation System (CRS) 308: Customers start their traveling experience with ticket booking and reservation. Through different sales channels, mostly through travel agencies, customers reserve and then purchase their tickets. The booking and reservation system 308 includes the following data elements:

Booking: who made the reservation;

Ticketing: who actually purchased the tickets;

Sales channels and travel agency: the media through which customers reserved and purchased the tickets; and

Base fare and discount: base fare is the full price (or expected revenue) set by the airline; Discount shows how much the airline discounted any particular ticket.

Ticket 316: Ticket 316 includes tickets actually issued. Ticket data includes:

Ticket number;

Issuing Date;

Carrier ID;

Agency ID;

Issuing city code;

Customer identification number(which may different from the Customer FF ID);

Customer name;

Customer address;

Flight number;

Departing/destination airports;

Scheduled departing/arrival time;

Route;

Fare amount;

Airport fee;

Taxes; and

Transferring code indicating whether the passenger was transferred from another airline, or within the same airline but to a different flight.

Check-in 318: When the customer actually boards the airplane, the ticket sold becomes the airline's actual revenue. The check-in data will confirm who actually flew.

Flight 310: Flight data probably is the most comprehensive and complete data the airlines have. Each flight represents a one-way, one take-off-to-landing segment. This data includes:

Flight number;

Departing airport;

Destination airport;

Scheduled departure/arrival time;

Route;

Legs;

Distance flown;

Equipment;

Crew;

Service classes;

Actual departure/arrival time; and

Enplanement-number of passengers boarded on the flight.

Actual (Coupon) Revenue 320: Each passenger on a flight (except the passengers on a reward flight) generates revenue to the airline. The trip also adds mileage flown to the frequency flyers' earned points. The data elements include:

Ticket number;

Ticket issued date;

Flight number;

Actual Revenue (or Coupon Revenue);

Coupon originating/destination airports;

Mileage;

Flight leg for each coupon;

Cabin codes.

Base fare;

Discounting coding; and

Agency coding.

Reward Flight 314: When frequent flyers accumulate enough points from their trips, the airline agrees to redeem these points by offering them a free trip to selected destinations or an upgrade in passenger service class. A passenger flying on a reward flight generates no revenue but does incur costs to the airline. These reward flights need to be separated and identified. Furthermore, how an airline rewards its frequent flyers, and how a passenger uses the reward program, may have significant influence on loyalty/defection behavior.

Market Share 322: Market share is very important information for retention models. Since the definition of defection depends on the competitiveness of the market, the market share data provides a measure to every O&D market the airline serves. The market share is measured as a percentage of the following: frequency of flights, equipment used, number of stops and connections, and passenger volume.

Internal Data Sources

There are three flows in an airline: passenger, equipment and crew. The airline's operation and planning processes focus on these three flows. For retention models, the equipment and crew flows are less important. At the center of retention is the passenger flow. Airlines typically possess the following operational data sources:

Customer data: Airlines may have customer data through certain channels or contact with customers. This data covers both frequent flyers and non-frequent flyers. The data is highly valuable for retention if the records are linked back to flight and revenue databases.

Frequent Flyer Program Data: Airlines usually have good records on the members of the frequent flyers program, particularly the elite club members.

Booking/Reservation data: Airlines have a massive reservation system called Computerized Reservation System (CRS) 308. The booking process is conducted using this system; however, the records are usually short-lived (i.e, they are purged periodically). In order to keep all these records for at least the modeling period, a data warehouse, or a facility to store the historical data, is necessary.

Travel Agency Data: This data includes agency codes, location and business types, contract type, share of sales, and loyalty of agency.

Flight data: As we have said, this is the most comprehensive and complete database airlines possess. Almost all operational data is contained here or derived from here. This database covers flights, scheduling, route, airports, and other information.

Revenue Management: Revenue management is a key part of airline operations. Airlines use the revenue management models to forecast demand and expected revenue. The base fare, coupon revenue, and mileage-seat capacity are found here.

Ticketing data: Ticketing data is the output of the booking process; however, this data, like that in the CRS, needs to be stored in a data warehouse for modeling use.

TCN (Ticket Control Number): This data contains all information when a ticket was issued (=purchased by a customer); and

PRA (Passenger Revenue Accounting): This data contains ticketing data but only when the ticket was collected, which means that the passenger actually boarded the airplane.

Airline data sources are usually fragmented and stored in different legacy systems. While reservation and flight operational data are on mainframe computers, marketing data may be on different systems, such as Informix or other database systems. All major airlines operate in a so-called line and staff organizational structure. The line organization includes all departments and personnel directly involved with the airlines services: operations, maintenance, and sales and marketing. The staff organization includes special departments and personnel such as law, accounting and finance, employee relations, and public relations. The airline data sources are created, maintained and used by these different departments and modeler needs to know the data sources unless there is a data warehouse in place. All operational data needs to be summarized.

External Data Sources

More data is always desirable and external data, including business and other socio-economic information helps interpret data and enhances predictability and accuracy of the models. However, external data is not cheap to secure so the marginal benefit of including external data into model building is a delicate issue. Including external data depends on the following considerations:

Airline's objective for the modeling project;

Availability and extent of the external data coverage;

Cost of the external data;

Analysts' experience in using the external data; and

Measurements of the modeling results improvement.

The decision to obtain external data is based upon a cost and benefit analysis. Experience indicates that external data contributes to the analytical models and some external data elements prove to be significant predictive variables in the models. In addition, these data elements provide customers classification information. Furthermore, as described previously, a customer's travel pattern may be affected by a job change or other factors. Therefore, external data, including information on such issues, may be vital to derive the response variable for the retention models.

Available data sources, public or private, external to the carrier are discussed next.

Public Data Sources

Unlike other industries, the airline industry has vast data sources that are available in the public domain. Although the data may need to be purchased, use of it is generally not restricted and in some cases, the data may be available from third party vendors who have cleaned it up to make it easier to incorporate in a data warehouse. The following is a list of sources for airline related data. Some of the data sources listed here are for U.S. airlines only. An engagement with an international airline may require more data discovery at the beginning of the project.

Department of Transportation (DOT)

http//www.dot.gov

http//www.bts.gov

The Department of Transportation (DOT) and the Bureau of Transportation Statistics (BTS) possess vast amounts airline data. Some of the data is listed below:

Forms 41 and 198C: Quarterly information provided by each carrier that includes revenue, cost, employee count, and traffic (RPM, ASM, fuel usage) by equipment and by airport.

T3: Monthly airport statistics (operation, enplanement) by equipment and carrier.

T100: Monthly segment statistics (available seats, enplanement, distance, block time, schedule time) by equipment and carrier

O & D Survey: Quarterly information based on 10% of ticket sample on each city pair served.

Airline Service Quality Performance (ASQP): Actual flight time records vs. published schedule for each flight.

Customer Complaint: Summarized by airline.

Federal Aviation Administration (FAA):—Terminal Area Forecast (TAF) and Historical and forecast data for annual operations, enplanement at airport level, published annually.

Official Airline Guide (OAG)

Schedule information published monthly including origin, departure time, destination, arrival time, equipment, date of service.

Boeing

Current Market Outlook: Worldwide forecast of traffic and equipment demand by region, published annually.

Rolls-Royce

Market Outlook: Worldwide forecast of traffic, equipment and engine demand by region, published annually.

NASA

Aviation System Analysis Capability (ASAC): A complex system under development to forecast the capacity of air space and airports, traffic volume, equipment, carriers, environment and safety.

All of the above data sources are operational-oriented, not customer-focused and most of them are aggregated data. However, the information may prove to be valuable, particularly in scheduling and market segmentation, to help define the defection and targeting population, and thus enhance the predictive power of the model.

Private Data Sources

Other data on airlines and on related issues are available from private vendors. This data usually needs to be purchased, and there are restrictions on use and distribution of the data.

Data may be available from the following private vendors:

Dun & Bradstreet;

Acxiom;

Experian;

Credit Bureau Data Sources; and

American Express;

The data may include the following information:

Individual Personal Identification Number (PIN);

Household PIN;

General Household Information, including:

Date of Birth;

Home Owner;

Address;

Length of Residence;

Dwelling Unit Size;

Geo Code;

Census Data;

All additional household members with name, gender and relationship; and

Number of children/age range.

Economic Data, including:

Educational Data;

Individual/Household Income (actual or estimated);

Geographic income percentile;

Occupation Category;

Employer (current, past);

Industry Mail Presence Indicator;

Home Business Indicator;

Business Owner Indicator; and

Direct Mail response.

Travel Related Data, including:

Frequent Flyer in Household;

Travel, Domestic;

Travel, International

Vacation Home/Time Sharing;

Credit Cards/Debit Cards: Card Name, Card Type, Card Category;

Rental Car data; and

Hotel Data.

Lifestyle Data, including:

Neighborhood Lifestyle Cluster;

Household Lifestyle Cluster;

Vendor Specific Data; and

Targeting Code.

Data Extraction

The data extraction tasks are now described. Data extraction consists of mapping the data, extracting the data from all data sources, cleaning and conditioning the data, and creating the analytical data file. This section does describe the procedures to extract data from various sources to a data warehouse as there are many known methods in the art. The goal of extracting data is to build an analytical data file used to perform data analysis and build retention models. Therefore, successful completion of the data extraction process is a prerequisite to conducting data analysis and analytical modeling. The data extraction process is separate and distinct from the analysis and modeling process.

Mapping the Data Sources

It is common for computer systems that process and store various data sources to be incompatible. If a data warehouse is in place, the data warehouse will facilitate access to data that have been transformed and migrated. If there is no data warehouse, then it is necessary to bring data from different sources to the same format by using data transport tools to transform the data, as is known in the art.

All data sources need to be mapped and linked. If there is no data warehouse, the data is mapped with the help of airline personnel. For performing these steps, identifying a unique “Key” field is fundamental. For example, each customer may have an assigned account ID and each agent may also have an assigned Agent ID. The data should be mapped and linked according to those IDs and the following data sources:

All internal operational data sources from different legacy systems should be linked and mapped so that each customer has a unique record, which includes all necessary fields;

Travel Agency data should be linked to customer data; and

If there is external data, the external data should be linked back to internal data.

Extract Data

When all necessary data linkages are established, a software tool (such as, SAS) can be used to extract data from all the data sources and generate a database including all the data fields and records. The following data extraction methods can be used:

Most statistical software packages can handle data in an ASCII flat file format;

Some software packages, such as SAS, have facilities to directly transfer PC based files, such as dif, or .db files, to their own data file format;

Some software packages have the facilities to directly link and interface with database server or database systems; and

If a data warehouse, such as Teradata is in place, analysts can extract needed data elements from the data warehouse.

No matter which method or utility is used to extract the data, an important caveat is to note the data size. It is assumed that there is a large amount of data including hundreds and thousands of records and hundreds of fields. Some facilities may have size limits or require that the appropriate size limits be defined to handle the data properly.

Data Cleansing and Conditioning

When all necessary internal and external data sources are identified and extracted, data needs to be cleaned and conditioned because data is rarely in a format or condition suitable for analysis purposes. The following are data cleansing and conditioning considerations:

Summarization—Transactional data contains very detailed information that is not useful to analysts and analysts decide the correct level of data detail. Analysts usually need to “roll up” data. For example, customers' revenue contribution is summarized on a monthly basis though these data are stored on a per-flight basis. The time band of the customer's flight needs to be summarized to represent the customer's flying pattern, where detailed up to the minute records exist.

Inconsistent Data Encoding—When information is gathered from various sources, the same data may be represented differently. Some examples include:

A customer ID in one data source is a ten-digit numeric number but in another data source it is a character field;

A revenue amount may be recorded in dollars or hundred dollar units depending on the sources of data;

Ratios may be represented in several different ways, for example, fifty-five point four percent, can be displayed as 55.4, 0.554, or 55.4%;

A negative number, such as negative ten, can be displayed either as −10, (10), or 10 (in red color);

All date fields (such as MM/DD/YY) need to be transformed, formatted, or coded according to the rules of the analytical software; and

Multiple abbreviations are another problem. State, city, street address, name of the customer, may be coded differently, e.g., California may appear as “CA,” “Cal.,” or “Calif.”

Textual Data—In many cases, text fields contain irrelevant data analysis information. If the data is relevant, it is better to re-code the data into different easier to use data formats. It is extremely important to be careful in recognizing comma, space, tab, and letter cases, to correctly code data.

Time Component of Data—Usually the data obtained from operational systems contain time series components, which is very important information. It is very important to make the time components reflect the time sequential nature. Particularly for some data classification procedures (such as CHAID). Poor representation of time sequential data prevents the procedures from finding patterns related to time series.

As an example, if the data contains the frequency values for the past six months, by coding the data as “FV01,” “FV02,” and so on, the procedure recognizes that FV01 precedes FV02, FV02 precedes FV03. In addition, if the data has time series of mileage, coded as “ML01,” “ML02,” and so on, the procedures may not be able to find that FV01 and ML01 actually occurred in the same month. Failing to recognize the time sequential nature of data causes important information to be lost. Continuous decline in FV or mileage in the past six months may indicate that the customer's need for air travel has changed or the customer has or is likely to, change carriers. If the data cannot capture this information, the model fails in predicting this trend.

Another approach is to derive variables capturing the “changes” over time, if no time series components have been established.

Blanks, Missing Values, and Anomalies—Blanks and missing values are another common yet important problem. Blanks and missing values are coded differently on legacy systems. If a data warehouse is in place, the data warehouse's data loading script may code blanks and missing values based on internal rule. It is important to be careful in recognizing and coding these blanks or missing values. The following are examples.

If a customer's number of contact field is blank, certain analytical software may treat this as “missing”. However, this blank field is not missing. It represents that a customer has not been contacted by the airline. In this case, the analyst should code this blank field as “0” instead of keeping it as a blank.

In other cases, avoid using “0” (zero) when filling in blanks or missing values. Zero, in many systems, has specific meanings. As an example, an external data vendor providing commercial credit score class data uses “0” as an indication of “Out of Business” and blank as an indication of “not available.” In this case, if the blanks are treated as “missing,” then not only will the data size be significantly reduced, but valid information is lost. In dealing with this problem, data needs to be transformed and a new variable needs to be derived

A missing value may be coded as a blank, “.”, “_”, “N/A”, “NULL”, or “99999999”. All these values need to be clarified and re-coded.

Several methods are used to fill in the blank or missing fields. However, analysts should be careful to choose one to use for the field. One way to fill the missing or blank field is to use average values calculated from that field, but some missing fields cannot be filled with average, minimum, or maximum values. Again, for customer contact, a missing field may simply represent no contact, and this field should not be filled with average or other values.

There may be some anomalies. Negative coupon revenue may be an anomaly, particularly if a customer account constantly shows negative coupon revenue values over the investigated time. There may be negative coupon value for a reward flight, but not for the entire period. When this kind of problem is encountered, the airline personnel need to provide some explanations as to why and how to transform or re-code this field. For the sake of data integrity, if no explanation or remedy is found, this kind of data record should be eliminated from the modeling process.

If a client airline installed a data warehouse, most of the data problems are resolved through data transformation. However, some coding problems still need to be resolved, such as how to code missing values or blanks. If there is no data warehouse in place, then the data needs to be cleaned and conditioned in order to generate a suitable database.

Analytical Data File

Once the data is sufficiently clean and complete, an analytical data file is generated. If SAS is the tool used, then follow the SAS data steps and procedures to load the data into a SAS data set. This analytical data file is used for further data analysis and for the modeling process. The analytical data file should satisfy the following criteria:

Internal operational data, such as flight, O&D, mileage, and revenue, are appropriately summarized;

Each record has a unique customer ID number;

No duplicate records;

If external data is available, external data records match one-by-one with the corresponding internal data records; and

Records in the analytical data file consist of the population being investigated.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of building a customer retention model comprising the following steps:
identifying data elements;
identifying data sources;
laying out a data file format;
identifying statistical and analytical packages; and
applying statistical and analytical packages to data from data sources fulfilling data elements identified in the data file format to perform customer retention.

2. The method as claimed in claim 1, wherein the data elements include:
frequent flyer program membership information;
passenger flying data;
booking channel data;
ticketing data; and
costs.

3. The method as claimed in claim 1, wherein the data sources include at least one of an internal data source and an external data source.

4. The method as claimed in claim 3, wherein the internal data source includes:
customer data;
revenue management data;
flight scheduling data;
sales channel data; and
travel agency data.

5. The method as claimed in claim 3, wherein the external data source includes at least one of a public data source and a private data source.

6. The method as claimed in claim 5, wherein the public data source includes Department of Transportation data, Federal Aviation Administration data, Official Airline Guide data, Boeing data, Rolls-Royce data, and NASA data.

7. The method as claimed in claim 5, wherein the private data source includes Dun & Bradstreet data, Acxiom data, Experian data, Credit Bureau Data Sources, and American Express data.

8. A method of building a customer retention model comprising the following steps:
identifying data elements;
identifying data sources;
laying out a data file format;
identifying statistical and analytical packages; and
applying statistical and analytical packages to data from data sources fulfilling data elements identified in the data file format to identify customers for customer retention.

9. The method as claimed in claim 8, wherein the data elements include:
frequent flyer program membership information;
passenger flying data;
booking channel data;
ticketing data; and
costs.

10. The method as claimed in claim 8, wherein the data sources include at least one of an internal data source and an external data source.

11. The method as claimed in claim 9, wherein the internal data source includes:
customer data;
revenue management data;
flight scheduling data;
sales channel data; and
travel agency data.

12. The method as claimed in claim 9, wherein the external data source includes at least one of a public data source and a private data source.

13. The method as claimed in claim 11, wherein the public data source includes Department of Transportation data, Federal Aviation Administration data, Official Airline Guide data, Boeing data, Rolls-Royce data, and NASA data.

14. The method as claimed in claim 11, wherein the private data source includes Dun & Bradstreet data, Acxiom data, Experian data, Credit Bureau Data Sources, and American Express data.

15. A method of identifying highly valued customers using a Customer Value Metric Model comprising the following steps:
identifying customer value criteria;
identifying customer data elements;
identifying data sources of the data elements;
applying a Customer Value Metric Model to data from the data sources in accordance with the customer value criteria to identify high value customers.

16. A method of identifying highly valued customers using a Customer Value Metric Model comprising:
determining a frequency value for each customer;
determining a net revenue contribution value for each customer;
scoring the frequency value and net revenue contribution value for each customer; and
identifying the highly valued customers by ranking the customers based on the score.

17. The method as claimed in claim 4, comprising:
ranking the customers based on the frequency value score.

18. The method as claimed in claim 4, comprising:
ranking the customers based on the net revenue contribution value score.

19. The method as claimed in claim 4, further comprising:
sorting the scores based on score pairs including frequency value and net revenue contribution value.

20. The method as claimed in claim 19, further comprising:
sorting matching score pairs based on net revenue contribution value;
dividing the customers into N groups;
assigning a numerical value 1-N to each group; and
ranking the customers based on the assigned numerical value to identify the highly valued customers.

21. The method as claimed in claim 20, wherein N is 100.
